(19) United States
(12) Patent Application Publication
(10) Pub. No.: US 2024/0196124 A1
(43) Pub. Date: Jun. 13, 2024

(54) MICROPHONE ARRAYS TO OPTIMIZE THE ACOUSTIC PERCEPTION OF AUTONOMOUS VEHICLES

(71) Applicant: TuSimple, Inc., San Diego, CA (US)

(72) Inventors: Pengji Duan, Tucson, AZ (US); Yusheng Ding, Tucson, AZ (US); Qiwei Li, Tucson, AZ (US)

(21) Appl. No.: 18/517,517

(22) Filed: Nov. 22, 2023

Related U.S. Application Data
(60) Provisional application No. 63/386,967, filed on Dec. 12, 2022.

(51) Int. Cl. H04R 1/08; B60W 10/18; B60W 10/20

(52) U.S. Cl. CPC H04R 1/083; B60W 10/18; B60W 10/20; B60W 2420/54; B60W 2510/18; B60W 2510/20; H04R 2201/40; H04R 2499/13

(57) ABSTRACT

A system comprises a microphone array and a processor. The microphone array detects first sound signal and the second sound signal. Each of the first and second sound signals has a particular frequency band. Each of the first and second sound signals is originated from a particular sound source. The processor receives the first and second sound signals. The processor amplifies the first sound signals, each with a different amplification order. The processor disregards the second sound signal, where the second sound signal includes interference noise signals. The processor determines that the first sound signals indicate that a vehicle is within a threshold distance from an autonomous vehicle and traveling in a direction toward the autonomous vehicle. In response, the processor instructs the autonomous vehicle to perform a minimal risk condition operation. The minimal risk condition operation includes pulling over or stopping the autonomous vehicle.

### RELATED APPLICATION AND CLAIM TO PRIORITY

This application claims priority to U.S. Provisional Application No. 63/386,967 filed Dec. 12, 2022, and titled “MICROPHONE ARRAYS TO OPTIMIZE THE ACOUSTIC PERCEPTION OF AUTONOMOUS VEHICLES,” which is incorporated herein by reference.

### TECHNICAL FIELD

The present disclosure relates generally to autonomous vehicles. More particularly, the present disclosure is related to microphone arrays to optimize the acoustic perception of autonomous vehicles.

### BACKGROUND

One aim of autonomous vehicle technology is to provide vehicles that can safely navigate with limited or no driver assistance. The autonomous vehicle relies on its sensors to detect objects on a road where the autonomous vehicle is traveling or intends to continue. A microphone array sensor associated with the autonomous vehicle may be used to detect sounds on the road. The microphone array sensor may detect all different sorts of sounds and noises that are not of interest for navigating the autonomous vehicle.

### SUMMARY

This disclosure recognizes various problems and previously unmet needs related to autonomous vehicle navigation, and more specifically to the lack of autonomous vehicle navigation technology to efficiently and effectively analyze sounds in navigating autonomous vehicles, for example, in cases where the autonomous vehicle encounters an emergency vehicle and the emergency vehicle's siren is turned on indicating that vehicles should move aside and allow the emergency vehicle to pass.

The disclosed system in the present disclosure improves (or optimizes) the acoustic perception of autonomous vehicles by implementing an unconventional microphone array. In the current acoustic perception technology for autonomous vehicles, microphones are mounted on various locations of an autonomous vehicle and capture all sorts of sounds and noises, including vehicle sounds, wind sounds, rain sounds, background sounds, autonomous vehicle tire sounds, and autonomous vehicle engine sounds. The captured sounds and noises may be used to detect objects on the road where the autonomous vehicle is traveling. However, the captured noises will lead to a degradation in the accuracy of object detection. In other words, the interference noises cause the processing of the sound signals of interest to be more complex. This will cause the objects (and their types, locations, along with other characteristics) to be not detected accurately. This, in turn, will lead to jeopardizing the safe and accurate navigation of the autonomous vehicle.

These technical problems may become more apparent in cases where acoustic perception processing algorithms are heavily relied on to navigate the autonomous vehicle or in cases where one or more other sensor types of the autonomous vehicle are not operational (e.g., damaged). Therefore, the current acoustic perception technology for autonomous vehicles does not provide a solution to improve the acoustic perception of autonomous vehicles.

Certain embodiments of the present disclosure provide unique technical solutions to technical problems of the current autonomous vehicle technologies and the acoustic perception technology for autonomous vehicles, including those problems described above to improve autonomous vehicle navigation. More specifically, the present disclosure contemplates a system and method to improve (or optimize) the acoustic perception of autonomous vehicles by implementing the unconventional microphone array and unconventional sound signal processing device. The sound signals captured by the microphone array may be transmitted to the sound signal processing device for processing.

The disclosed system may be configured to act as a spatial sound signal frequency band pass filter that is configured to transmit particular sound signal frequencies coming from an environment in front of or behind the autonomous vehicle and disregard (i.e., reflect or filter) other sound signal frequencies coming from front or other directions. The disclosed system may also be configured to amplify the transmitted sound signal frequencies coming from an environment in front of or behind the autonomous vehicle.

In certain embodiments, the transmitted sound signal frequencies may include a set of sound signal frequency segmentations (i.e., separated and distinct sound signal frequency bands). The set of sound signal frequency segmentations may be determined based on the various distances between the sound sensors forming the microphone array.

The disclosed system may be configured to amplify each sound signal segmentation with a different amplification order. This may be at lease due to the physical arrangement of the microphone sensors forming the microphone array. For example, by amplifying particular sound signal frequency segmentation(s) from particular direction(s) and disregarding other sound signal frequency segmentation(s) from any direction, the computational complexity of processing the particular sound signal frequency segmentation(s) is reduced. Therefore, less processing and memory resources are used to process the particular sound signal frequency segmentation(s) of interest—while the accuracy of the acoustic perception is improved. In this manner, the disclosed system provides the practical application of improving the acoustic perception of autonomous vehicles. This, in turn, leads to additional practical applications of reducing computational complexity for processing the particular sound signal frequency segmentation(s), reducing computational complexity in detecting objects (and their types, locations, and trajectories) from sounds of the objects, reducing processing and memory resources to implement the object detection from the sounds of the objects.

Furthermore, the disclosed system provides improvements to autonomous vehicle navigation technology. For example, by improving the acoustic perception of an autonomous vehicle, the objects (and their types, locations, trajectories, and other characteristics) are determined with more accuracy compared to the current technology—which leads to determining a safer traveling path with less computational complexity. In this manner, the disclosed system provides the practical application of improving autonomous vehicle navigation technology.

In a particular example, the microphone array and the sound signal processing device may be configured (e.g., tuned or designed) to detect and amplify a vehicle's siren sound (e.g., an emergency vehicle's sirens), vehicle's horn sounds, and the like, and disregard other sounds. Thus, in this particular example, identifying the emergency vehicle (its type, direction, and trajectory) becomes easier with less computational complexity compared to when all different sorts of noise signals are included in the sound signals and are processed. Upon detecting the emergency vehicle's siren sound (e.g., the emergency vehicle's siren sound is getting louder), the control device onboard the autonomous vehicle may determine that the emergency vehicle is traveling in a direction toward the autonomous vehicle. The control device may also determine the speed and other characteristics of the emergency vehicle. In response, the control device may instruct the autonomous vehicle to pull over or stop without hindering the traffic to allow the emergency vehicle to pass.

In this way, the disclosed system provides improvements to the acoustic perception technology for autonomous vehicles, improves the autonomous vehicle navigation technology, and provides a safer driving experience for the autonomous vehicle, surrounding vehicles, and pedestrians.

In certain embodiments, a system comprises a microphone array and a processor associated with an autonomous vehicle. The microphone array comprises a plurality of sound sensors, wherein the microphone array is mounted on an autonomous vehicle. The microphone array is configured to detect one or more first sound signals from one or more first sound sources. The microphone array is further configured to detect one or more second sound signals from one or more second sound sources. The processor is configured to receive the one or more first sound signals. The processor is further configured to receive the one or more second sound signals. The processor is further configured to amplify the one or more first sound signals. The processor is further configured to disregard the one or more second sound signals, wherein the one or more second sound signals comprise interference noise signals. The processor is further configured to determine that the one or more first sound signals indicate that a vehicle is within a threshold distance from the autonomous vehicle and traveling in a direction toward the autonomous vehicle. The processor is further configured to instruct the autonomous vehicle to perform a minimal risk maneuver operation in response to determining that the one or more first sound signals indicate that the vehicle is within the threshold distance from the autonomous vehicle and traveling in the direction toward the autonomous vehicle.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to improve the acoustic perception of autonomous vehicles;

FIG. 2 illustrates example configurations of a microphone array for autonomous vehicles;

FIG. 3A illustrates an isometric view of an autonomous vehicle with planar structures showing directions of arrivals of sound signals toward the autonomous vehicle;

FIG. 3B illustrates an example location of a microphone array on a side of an autonomous vehicle;

FIG. 4 illustrates an example flowchart of a method for improving the acoustic perception of autonomous vehicles;

FIG. 5 illustrates a block diagram of an example autonomous vehicle configured to implement autonomous driving operations;

FIG. 6 illustrates an example system for providing autonomous driving operations used by the autonomous vehicle of FIG. 5; and

FIG. 7 illustrates a block diagram of an in-vehicle control computer included in the autonomous vehicle of FIG. 5.

### DETAILED DESCRIPTION

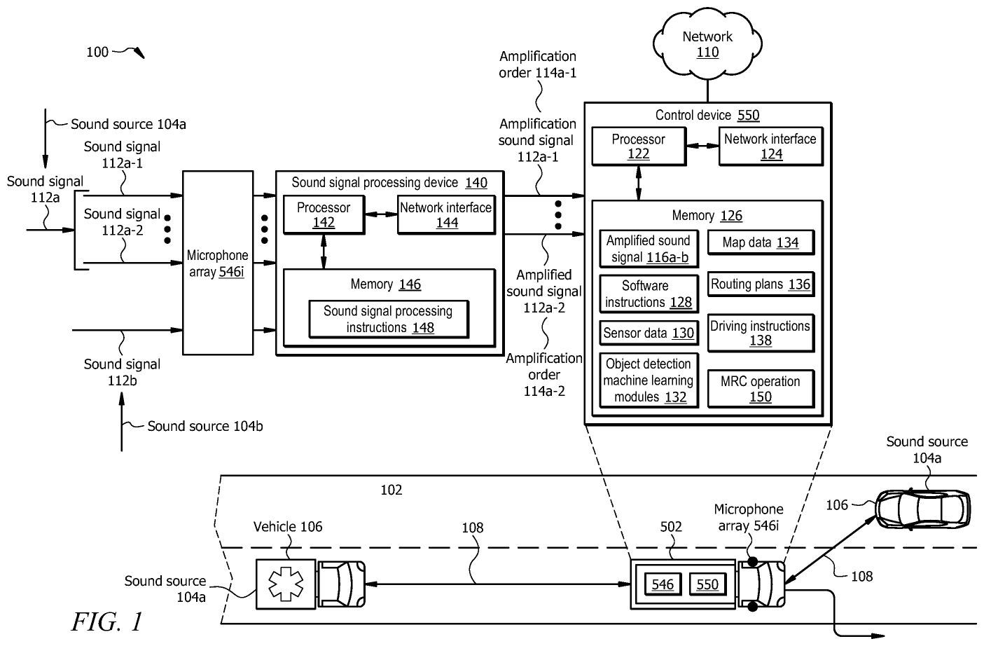

As described above, previous technologies fail to provide efficient, reliable, and safe solutions to analyze sound signals for navigating autonomous vehicles, for example, in cases where an emergency vehicle's siren is turned on indicating that vehicles should move aside and allow the emergency vehicle to pass. The present disclosure provides various systems, methods, and devices to navigate autonomous vehicles, for example, in cases where an emergency vehicle's siren is turned on indicating that vehicles should move aside and allow the emergency vehicle to pass. Embodiments of the present disclosure and its advantages may be understood by referring to FIGS. 1 through 7. FIGS. 1 through 7 are used to describe a system and method to navigate autonomous vehicles, for example, in cases where an emergency vehicle's siren is turned on indicating that vehicles should move aside and allow the emergency vehicle to pass.

### System Overview

FIG. 1 illustrates an embodiment of a system 100 configured to optimize or improve the acoustic perception of autonomous vehicles 502. FIG. 1 further illustrates a simplified schematic of a road 102 traveled by an autonomous vehicle 502. In certain embodiments, system 100 comprises the autonomous vehicle 502. The autonomous vehicle 502 includes a control device 550 operably coupled to a sound signal processing device 140. The control device 550 comprises a processor 122 in signal communication with a memory 126. Memory 126 stores software instructions 128 that when executed by the processor 122 cause the control device 550 to perform one or more operations described herein. The sound signal processing device 140 may include one or more processors 142 in signal communication with a memory 146. Memory 146 stores sound signal processing instructions 148 that when executed by the one or more processors 142 cause the sound signal processing device 140 to perform one or more operations described herein. The autonomous vehicle 502 is communicatively coupled to other autonomous vehicles 502, systems, devices, servers, databases, and the like via a network 110. Network 110 allows the autonomous vehicle 502 to communicate with other autonomous vehicles 502, systems, devices, servers, databases, and the like. In other embodiments, system 100 may not have all of the components listed and/or may have other elements instead of, or in addition to, those listed above. System 100 may be configured as shown or in any other configuration.

In general, system 100 improves (or optimizes) the acoustic perception of the autonomous vehicles 502 by implementing an unconventional microphone array 546i and an unconventional sound signal detection device 140. In the current acoustic perception technology for autonomous vehicles, microphones are mounted on various locations of an autonomous vehicle and capture all sorts of sounds and noises, including vehicle sounds, wind sounds, rain sounds, background sounds, autonomous vehicle tire sounds, and autonomous vehicle engine sounds. The captured sounds and noises may be used to detect objects on the road where the autonomous vehicle is traveling. However, the captured noises will lead to a degradation in the accuracy of object detection. In other words, the interference noises cause the processing of the sound signals of interest to be more complex. This will cause the objects (and their types, locations, and other characteristics) to be not detected accurately. This, in turn, will lead to jeopardizing the safe and accurate navigation of the autonomous vehicle.

These technical problems may become more apparent in cases where acoustic perception processing algorithms are heavily relied on to navigate the autonomous vehicle or in cases where one or more other sensor types of the autonomous vehicle are not operational (e.g., damaged). Therefore, the current acoustic perception technology for autonomous vehicles does not provide a solution to improve the acoustic perception of autonomous vehicles.

The present disclosure provides a technical solution to technical problems of acoustic perception technology for autonomous vehicles, including those mentioned above. More specifically, the present disclosure contemplates a system and method to improve (or optimize) the acoustic perception of autonomous vehicles 502 by implementing the unconventional microphone array 546i and unconventional sound signal processing device 140. The sound signals captured by the microphone array 546i may be transmitted to the sound signal processing device 140 for processing.

In certain embodiments, the system 100 (e.g., via the microphone array 546i and the sound signal processing device 140) is configured to act as a spatial sound signal frequency band pass filter that is configured to transmit particular sound signal frequencies coming from an environment in front of or behind the autonomous vehicle 502 and disregard (i.e., reflect or filter) other sound signal frequencies coming from front or other directions. The system 100 (e.g., via the microphone array 546i and the sound signal processing device 140) may also be configured to amplify the transmitted sound signal frequencies coming from an environment in front of or behind the autonomous vehicle 502.

In certain embodiments, the transmitted sound signal frequencies may include a set of sound signal frequency segmentations (i.e., separated and distinct sound signal frequency bands). The set of sound signal frequency segmentations may be determined based on the various distances between the sound sensors forming the microphone array 546i.

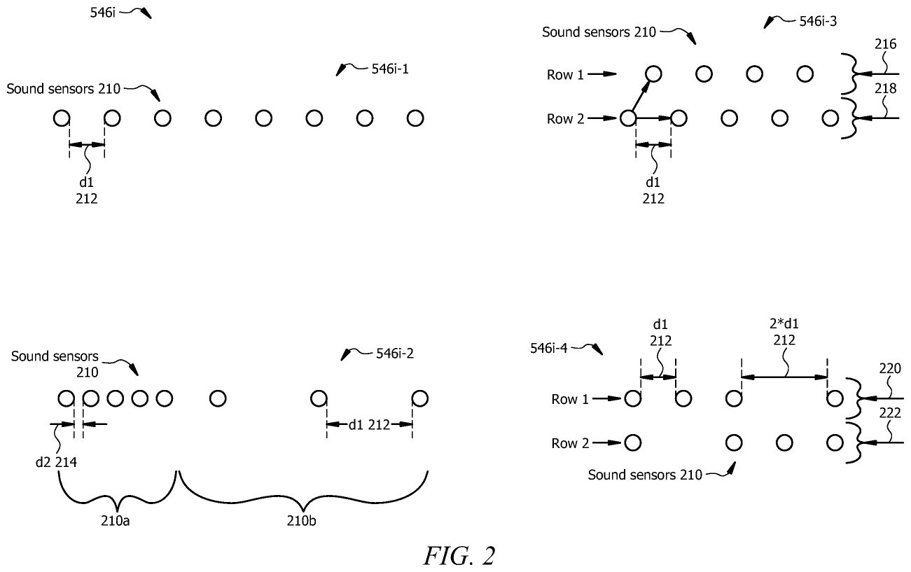

The system 100 (e.g., via the microphone array 546i and the sound signal processing device 140) may be configured to amplify each sound signal segmentation with a different amplification order. This may be at lease due to the physical arrangement of the microphone sensors forming the microphone array 546i. Various physical arrangements of the sound sensors forming various configurations of the microphone array 546i are described in great detail in FIG. 2.

For example, by amplifying particular sound signal frequency segmentation(s) from particular direction(s) and disregarding other sound signal frequency segmentation(s) from any direction, the computational complexity of processing the particular sound signal frequency segmentation(s) is reduced. Therefore, less processing and memory resources are used to process the particular sound signal frequency segmentation(s) of interest—while the accuracy of the acoustic perception is improved. In this manner, the disclosed system 100 provides the practical application of improving the acoustic perception of autonomous vehicles.

This, in turn, leads to additional practical applications of reducing computational complexity for processing the particular sound signal frequency segmentation(s), reducing computational complexity in detecting objects (and their types, locations, and trajectories) from sounds of the objects, reducing processing and memory resources to implement the object detection from the sounds of the objects.

Furthermore, the disclosed system 100 provides improvements to the autonomous vehicle navigation technology. For example, by improving the acoustic perception of an autonomous vehicle, the object (and their types, locations, and trajectories) are determined with more accuracy compared to the current technology—which leads to determining a safer traveling path with less computational complexity. In this manner, the system 100 provides the practical application of improving autonomous vehicle navigation technology.

In a particular example, the microphone array 546i and the sound signal processing device 140 may be configured (e.g., tuned or designed) to detect and amplify a vehicle's siren sound (e.g., a vehicle's emergency sirens), vehicle's horn sounds, and the like, and disregard other sounds. Thus, in this particular example, identifying the emergency vehicle (its type, direction, trajectory, and other characteristics) becomes easier with less computational complexity compared to when all different sorts of noise signals are included in the sound signals and are processed. Upon detecting the emergency vehicle's siren sound (e.g., the emergency vehicle's siren sound is getting louder), the control device 550 may determine that the emergency vehicle is traveling in a direction toward the autonomous vehicle 502. The control device 550 may also determine the speed and other characteristics of the emergency vehicle. In response, the control device 550 may instruct the autonomous vehicle 502 to pull over or stop without hindering the traffic to allow the emergency vehicle to pass.

In this way, the system 100 provides improvements to the acoustic perception technology for autonomous vehicles, improves the autonomous vehicle navigation technology, and provides a safer driving experience for the autonomous vehicle 502, surrounding vehicles, and pedestrians.

### System Components

Network 110 may include any interconnecting system capable of transmitting audio, video, signals, data, messages, or any combination of the preceding. Network 110 may include all or a portion of a local area network (LAN), a wide area network (WAN), a metropolitan area network (MAN), a personal area network (PAN), a wireless PAN (WPAN), an overlay network, a software-defined network (SDN), a virtual private network (VPN), a packet data network (e.g., the Internet), a mobile telephone network (e.g., cellular networks, such as 4G or 5G), a plain old telephone (POT) network, a wireless data network (e.g., WiFi, WiGig, WiMAX, etc.), a long-term evolution (LTE) network, a universal mobile telecommunications system (UMTS) network, a peer-to-peer (P2P) network, a Bluetooth network, a near field communication (NFC) network, a Zigbee network, a Z-wave network, a WiFi network, and/or any other suitable network.

### Example Autonomous Vehicle

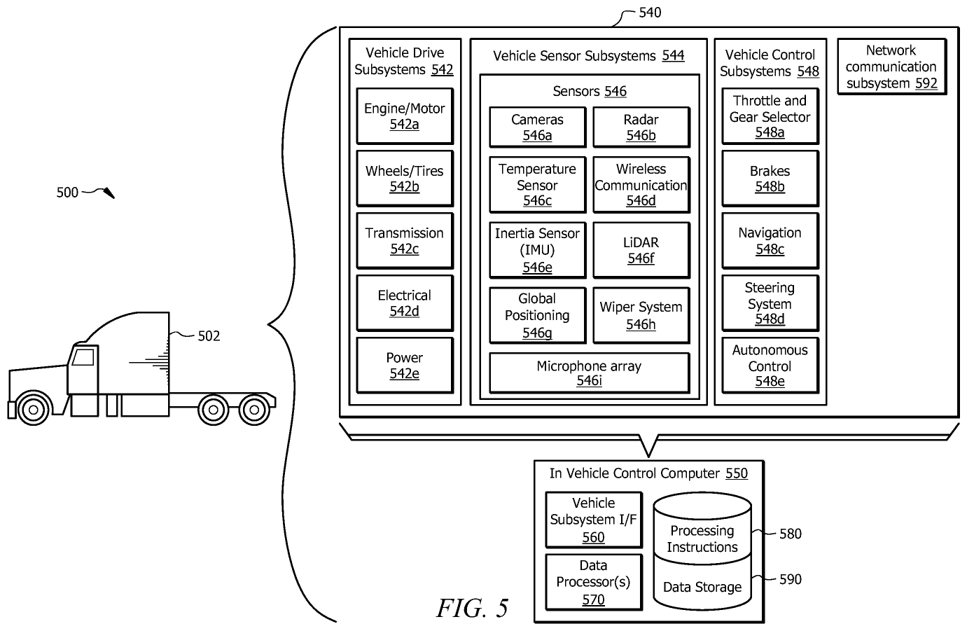

In certain embodiments, the autonomous vehicle 502 may include a semi-truck tractor unit attached to a trailer to transport cargo or freight from one location to another location (see FIG. 5). The autonomous vehicle 502 is generally configured to travel along a road in an autonomous mode. The autonomous vehicle 502 may navigate using a plurality of components described in detail in FIGS. 5-7. The operation of the autonomous vehicle 502 is described in greater detail in FIGS. 5-7. The corresponding description below includes brief descriptions of certain components of the autonomous vehicle 502.

Control device 550 may be generally configured to control the operation of the autonomous vehicle 502 and its components and to facilitate autonomous driving of the autonomous vehicle 502. The control device 550 may be further configured to determine a pathway in front of the autonomous vehicle 502 that is safe to travel and free of objects or obstacles, and navigate the autonomous vehicle 502 to travel in that pathway. This process is described in more detail in FIGS. 5-7. The control device 550 may generally include one or more computing devices in signal communication with other components of the autonomous vehicle 502 (see FIG. 5). In this disclosure, the control device 550 may interchangeably be referred to as an in-vehicle control computer 550.

The control device 550 may be configured to detect objects on and around a road traveled by the autonomous vehicle 502 by analyzing the sensor data 130 and/or map data 134. For example, the control device 550 may detect objects on and around the road by implementing object detection machine learning modules 132. The object detection machine learning modules 132 may be implemented using neural networks and/or machine learning algorithms for detecting objects from images, videos, infrared images, point clouds, audio feed, Radar data, etc. The object detection machine learning modules 132 are described in more detail further below. The control device 550 may receive sensor data 130 from the sensors 546 positioned on the autonomous vehicle 502 to determine a safe pathway to travel. The sensor data 130 may include data captured by the sensors 546.

Sensors 546 may be configured to capture any object within their detection zones or fields of view, such as landmarks, lane markers, lane boundaries, road boundaries, vehicles, pedestrians, road/traffic signs, among others. In some embodiments, the sensors 546 may be configured to detect rain, fog, snow, and/or any other weather condition. The sensors 546 may include a detection and ranging (LiDAR) sensor, a Radar sensor, a video camera, an infrared camera, an ultrasonic sensor system, a wind gust detection system, a microphone array, a thermocouple, a humidity sensor, a barometer, an inertial measurement unit, a positioning system, an infrared sensor, a motion sensor, a rain sensor, and the like. In some embodiments, the sensors 546 may be positioned around the autonomous vehicle 502 to capture the environment surrounding the autonomous vehicle 502. See the corresponding description of FIG. 5 for further description of the sensors 546.

### Control Device

The control device 550 is described in greater detail in FIG. 5. In brief, the control device 550 may include the processor 122 in signal communication with the memory 126 and a network interface 124. The processor 122 may include one or more processing units that perform various functions as described herein. The memory 126 may store any data and/or instructions used by the processor 122 to perform its functions. For example, the memory 126 may store software instructions 128 that when executed by the processor 122 causes the control device 550 to perform one or more functions described herein.

The processor 122 may be one of the data processors 570 described in FIG. 5. The processor 122 comprises one or more processors operably coupled to the memory 126. The processor 122 may be any electronic circuitry, including state machines, one or more central processing unit (CPU) chips, logic units, cores (e.g., a multi-core processor), field-programmable gate arrays (FPGAs), application-specific integrated circuits (ASICs), or digital signal processors (DSPs). The processor 122 may be a programmable logic device, a microcontroller, a microprocessor, or any suitable combination of the preceding. The processor 122 may be communicatively coupled to and in signal communication with the network interface 124 and memory 126. The one or more processors may be configured to process data and may be implemented in hardware or software. For example, the processor 122 may be 8-bit, 16-bit, 32-bit, 64-bit, or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors may be configured to implement various instructions. For example, the one or more processors may be configured to execute software instructions 128 to implement the functions disclosed herein, such as some or all of those described with respect to FIGS. 1-7. In some embodiments, the function described herein is implemented using logic units, FPGAs, ASICs, DSPs, or any other suitable hardware or electronic circuitry.

Network interface 124 may be a component of the network communication subsystem 592 described in FIG. 5. The network interface 124 may be configured to enable wired and/or wireless communications. The network interface 124 may be configured to communicate data between the autonomous vehicle 502 and other devices, systems, or domains. For example, the network interface 124 may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 122 may be configured to send and receive data using the network interface 124. The network interface 124 may be configured to use any suitable type of communication protocol as would be appreciated by one of ordinary skill in the art.

The memory 126 may be one of the data storages 590 described in FIG. 5. The memory 126 may be volatile or non-volatile and may comprise read-only memory (ROM), random-access memory (RAM), ternary content-addressable memory (TCAM), dynamic random-access memory (DRAM), and static random-access memory (SRAM). The memory 126 may include one or more of a local database, cloud database, network-attached storage (NAS), etc. The memory 126 may store any of the information described in FIGS. 1-7 along with any other data, instructions, logic, rules, or code operable to implement the function(s) described herein when executed by processor 122. For example, the memory 126 may store software instructions 128, sensor data 130, object detection machine learning modules 132, map data 134, routing plan 136, driving instructions 138, sound signals 112a-b, minimal risk condition (MRC) operation 150, and/or any other data/instructions. The software instructions 128 include code that when executed by the processor 122 causes the control device 550 to perform the functions described herein, such as some or all of those described in FIGS. 1-7. The memory 126 comprises one or more disks, tape drives, or solid-state drives, and may be used as an over-flow data storage device to store programs when such programs are selected for execution, and to store instructions and data that are read during program execution.

Object detection machine learning modules 132 may be implemented by the processor 122 executing software instructions 128, and may be generally configured to detect objects and obstacles from the sensor data 130. The object detection machine learning modules 132 may be implemented using neural networks and/or machine learning algorithms for detecting objects from any data type, such as images, videos, infrared images, point clouds, audio feed, Radar data, etc.

In some embodiments, the object detection machine learning modules 132 may be implemented using machine learning algorithms, such as Support Vector Machine (SVM), Naive Bayes, Logistic Regression, k-Nearest Neighbors, Decision Trees, or the like. In some embodiments, the object detection machine learning modules 132 may utilize a plurality of neural network layers, convolutional neural network layers, Long-Short-Term-Memory (LSTM) layers, Bi-directional LSTM layers, recurrent neural network layers, and/or the like, in which weights and biases of these layers are optimized in the training process of the object detection machine learning modules 132. The object detection machine learning modules 132 may be trained by a training dataset that may include samples of data types labeled with one or more objects in each sample. For example, the training dataset may include sample images of objects (e.g., vehicles, lane markings, pedestrians, road signs, obstacles, etc.) labeled with object(s) in each sample image. Similarly, the training dataset may include samples of other data types, such as videos, infrared images, point clouds, audio feed, Radar data, etc. labeled with object(s) in each sample data. The object detection machine learning modules 132 may be trained, tested, and refined by the training dataset and the sensor data 130. The object detection machine learning modules 132 use the sensor data 130 (which are not labeled with objects) to increase their accuracy of predictions in detecting objects. Similar operations and embodiments may apply for training the object detection machine learning modules 132 using the training dataset that includes sound data samples each labeled with a respective sound source and a type of sound. For example, supervised and/or unsupervised machine learning algorithms may be used to validate the predictions of the object detection machine learning modules 132 in detecting objects in the sensor data 130.

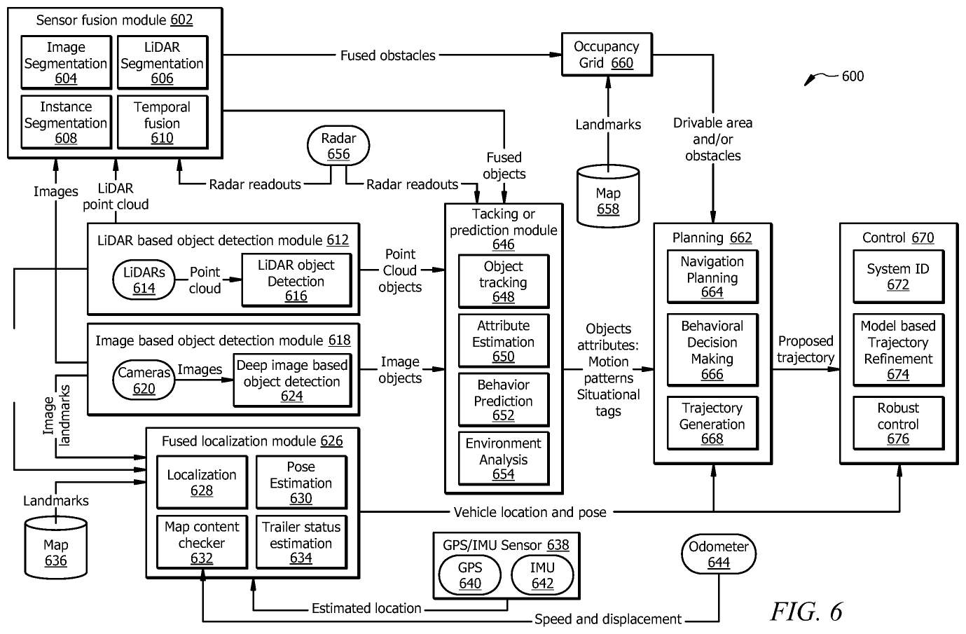

Map data 134 may include a virtual map of a city or an area that includes the road traveled by an autonomous vehicle 502. In some examples, the map data 134 may include the map 658 and map database 636 (see FIG. 6 for descriptions of the map 658 and map database 636). The map data 134 may include drivable areas, such as roads, paths, highways, and undrivable areas, such as terrain (determined by the occupancy grid module 660, see FIG. 6 for descriptions of the occupancy grid module 660). The map data 134 may specify location coordinates of road signs, lanes, lane markings, lane boundaries, road boundaries, traffic lights, obstacles, etc.

Routing plan 136 may be a plan for traveling from a start location (e.g., a first autonomous vehicle launchpad/landing pad) to a destination (e.g., a second autonomous vehicle launchpad/landing pad). For example, the routing plan 136 may specify a combination of one or more streets, roads, and highways in a specific order from the start location to the destination. The routing plan 136 may specify stages, including the first stage (e.g., moving out from a start location/launch pad), a plurality of intermediate stages (e.g., traveling along particular lanes of one or more particular street/road/highway), and the last stage (e.g., entering the destination/landing pad). The routing plan 136 may include other information about the route from the start position to the destination, such as road/traffic signs in that routing plan 136, etc.

Driving instructions 138 may be implemented by the planning module 662 (See descriptions of the planning module 662 in FIG. 6). The driving instructions 138 may include instructions and rules to adapt the autonomous driving of the autonomous vehicle 502 according to the driving rules of each stage of the routing plan 136. For example, the driving instructions 138 may include instructions to stay within the speed range of a road traveled by the autonomous vehicle 502, adapt the speed of the autonomous vehicle 502 with respect to observed changes by the sensors 546, such as speeds of surrounding vehicles, objects within the detection zones of the sensors 546, etc.

### Sound Signal Processing Component

Sound signal processing device 140 may generally be a device implemented in hardware and/or software, and is configured to process sound signals 112a-b and any other sound signals. The sound signal processing device 140 may process the sound signals 112a-b when the processor 142 executes the sound signal processing instructions 148. In certain embodiments, upon detecting the sound signals 112a-b, the microphone array 546i may communicate the sound signals 112a-b to the sound signal processing device 140 downstream relative to the microphone array 546i before the control device 550. The sound signal processing device 140 may be operably coupled to the microphone array 546i and the control device 550 via wires and/or wireless communications through the network interface 144

The sound signal processing device 140 (e.g., via the processor 142 executing the sound signal processing instructions 128) may be configured to implement sound signal processing, digital signal processing, frequency filtering algorithms, frequency amplifying algorithms, and frequency analyzing algorithms for processing the sound signals 112a-b. For example, the sound signal processing device 140 may include an Analog to Digital Convertor (ADC), Fast Fourier Transform (FFT) code/hardware device, Inverse FFT (IFFT) code/hardware device, band pass filters operating in different frequency bands, low pass filters operating in different frequency bands, high pass filters operating in different frequency bands, low noise filters, and other hardware and software resources to perform processing of the sound signals 112a-b. These components of the sound signal processing device 140 may be implemented within and/or by the processors 122.

In the illustrated embodiment, the sound signal processing device 140 is shown outside of the control device 550 and microphone array 546i. However, the present disclosure contemplates other embodiments. In certain embodiments, the control device 550 and the sound signal processing device 140 may be implemented in one device. In certain embodiments, the microphone array 546i and the sound signal processing device 140 may be implemented in one device. In one example embodiment, the sound signal processing device 140 may reside and be implemented in the microphone array 546i. Thus, the microphone array 546i may perform detecting, processing, filtering, and enhancing the sound signals, similar to that described above, and communicate the processed sound data to the control device 550.

In the same or another example embodiment, the sound signal processing device 140 may reside and be implemented in the control device 550. Thus, the microphone array 546i may communicate raw/unprocessed sound data to the control device 550, and the control device 550 may perform processing, filtering, and enhancing the sound signals. For example, the control device 550 (e.g., via the processor 122 executing the software instructions 128) may implement sound signal processing, digital signal processing, frequency filtering algorithms, frequency amplifying algorithms, and frequency analyzing algorithms for processing the sound signals 112a-b. For example, the control device 550 may include the component of the sound signal processing device 140 to perform processing of the sound signals 112a-b.

The sound signal processing device 140 may include one or more processor 142 in signal communication with a network interface 144 and a memory 146. The processor 142 comprises one or more processors operably coupled to the memory 146. The processor 142 may be any electronic circuitry, including state machines, one or more CPU chips, logic units, cores (e.g., a multi-core processor), FPGAs, ASICs, or DSPs. The processor 142 may be a programmable logic device, a microcontroller, a microprocessor, or any suitable combination of the preceding. The processor 142 may be communicatively coupled to and in signal communication with the network interface 144 and memory 146. The one or more processors may be configured to process data and may be implemented in hardware or software. For example, the processor 142 may be 8-bit, 16-bit, 32-bit, 64-bit, or of any other suitable architecture. The processor 142 may include an ALU for performing arithmetic and logic operations, processor registers that supply operands to the ALU and store the results of ALU operations, and a control unit that fetches instructions from memory and executes them by directing the coordinated operations of the ALU, registers and other components. The one or more processors may be configured to implement various instructions. For example, the one or more processors may be configured to execute sound signal processing instructions 148 to implement the functions disclosed herein, such as some or all of those described with respect to FIGS. 1-7. In some embodiments, the function described herein is implemented using logic units, FPGAs, ASICs, DSPs, or any other suitable hardware or electronic circuitry.

The network interface 144 may be configured to enable wired and/or wireless communications. The network interface 144 may be configured to communicate data between the sound signal processing device 140 and other devices, systems, or domains. For example, the network interface 144 may comprise an NFC interface, a Bluetooth interface, a Zigbee interface, a Z-wave interface, an RFID interface, a WIFI interface, a LAN interface, a WAN interface, a MAN interface, a PAN interface, a WPAN interface, a modem, a switch, and/or a router. The processor 142 may be configured to send and receive data using the network interface 144. The network interface 144 may be configured to use any suitable type of communication protocol as would be appreciated by one of ordinary skill in the art.

The memory 146 may be volatile or non-volatile and may comprise ROM, RAM, TCAM, DRAM, and SRAM. The memory 146 may include one or more of a local database, cloud database, NAS, etc. The memory 146 may store any of the information described in FIGS. 1-7 along with any other data, instructions, logic, rules, or code operable to implement the function(s) described herein when executed by processor 142. For example, the memory 146 may store sound signal processing instructions 148, sound signals 112a-b, and/or any other data/instructions. The sound signal processing instructions 148 include code that when executed by the processor 142 causes the sound signal processing device 140 to perform the functions described herein, such as some or all of those described in FIGS. 1-7. The memory 146 comprises one or more disks, tape drives, or solid-state drives, and may be used as an over-flow data storage device to store programs when such programs are selected for execution, and to store instructions and data that are read during program execution.

### Microphone Array

Microphone array 546i may be among the sensors 546 described in FIG. 5. The present disclosure contemplates various hardware configurations of the microphone array 546i. The various hardware configurations of the microphone array 546i are described in detail in FIG. 2. The description below describes a brief description of the microphone array 546i.

The microphone array 546i includes a plurality of sound sensors (210 in FIG. 2) and is generally configured to detect sound signals 112a-b and any other sound signals. Examples of the sound sensors within the microphone array 546i may include but are not limited to, acoustic sensors, acoustic pressure sensors, pressure microphones, pre-polarized condenser microphones, condenser microphones, and the like.

In certain embodiments, the sound sensors may be Micro-Electro-Mechanical System (MEMS) sensors. For example, a MEMS sound sensor may include an electrical circuitry that includes microchips, resistors, capacitors, inductors, etc., arranged and designed in a specific structural layout to perform the sound detection operation of the MEMS sound sensor. In certain embodiments, each sound sensor may be omnidirectional—meaning that it can receive and transmit sound signals from and in all directions.

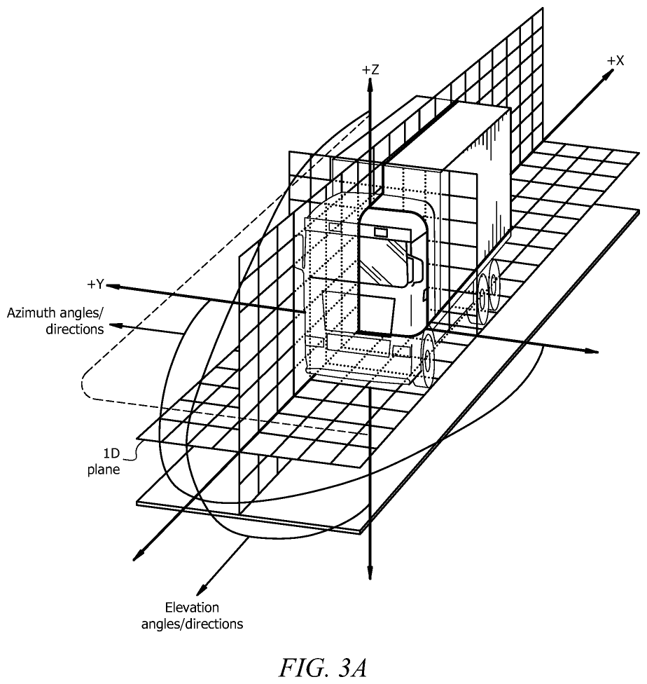

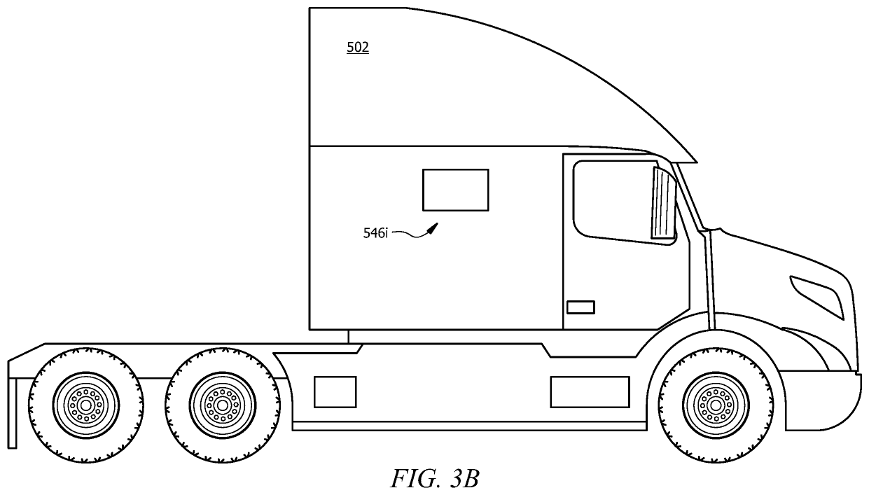

The microphone array 546i may be mounted on the sides of the autonomous vehicle 502 (see FIG. 3B for an example location of the microphone array 546i on the autonomous vehicle 502). The microphone array 546i may be mounted on the autonomous vehicle 502 such that the array of sound sensors 210 (see FIG. 2) is parallel to the ground. One instance of the microphone array 546i may be mounted on the left side of the autonomous vehicle 502, and another instance of the microphone array 546i may be mounted on the right side of the autonomous vehicle 502.

Referring to FIG. 2, FIG. 2 illustrates four non-limiting example hardware configurations/embodiments of the microphone array 546i. As can be seen in FIG. 2, the four non-limiting example hardware configurations of the microphone array 546i are referred to as microphone arrays 546i-1 through 546i-4. The non-limiting example hardware configurations of the microphone array 546i-1 through 546i-4 are described below.

### First Example Microphone Array Configuration

In the illustrated example, the first configuration/embodiment of the microphone array 546i-1 is arranged in a one-dimension (1D) plane. The 1D plane is a plane in space that is parallel to a road traveled by the autonomous vehicle 502. The 1D plane is illustrated in FIG. 3A.

Referring to FIG. 3A, the first configuration of the microphone array (546i-1 in FIG. 2) is arranged such that sound signals coming from azimuth angles/directions can be detected and enhanced. The azimuth angels/directions may refer to directions from the front of and behind the autonomous vehicle 502. The azimuth angles/directions may encompass directions from −x-axis of the 1D plane (front of the autonomous vehicle 502), to +y-axis of the 1D plane (right side of the autonomous vehicle 502), and to +z-axis of the 1D plane (top of the autonomous vehicle 502). In certain embodiments, sound signals coming from other directions may be disregarded or filtered.

Referring back to FIG. 2, the first configuration of the microphone array 546i-1 is arranged in a uniform linear array—meaning that each two adjacent sound sensors 210 are located at a particular distance (d1) 212 from each other. The distance 212 maybe 4 centimeters (cm), for example. In other examples, the distance 212 may be any suitable value.

In the illustrated example, the first configuration of the microphone array 546i-1 includes eight sound sensors 210, each adjacent pair of sound sensors 210 are separated by a distance 212. In other examples, the first configuration of the microphone array 546i-1 may include any suitable number of sound sensors 210.

In certain embodiments, the sound signal frequency range(s) that the first configuration of the microphone array 546i-1 is configured to detect and enhance is determined based on the distances between each pair of sound sensors 210. The detected and enhanced sound signal frequency bands may be calculated according to Equation (1) as below:

f=c/d Eq. (1)

where, f is the sound signal frequency that is detected by the sound sensor, c is the speed of sound (approximately 343 Meters Per Second (MPS)), and d is the distance between any two sound sensors 210.

The highest sound signal frequency that the first configuration of the microphone array 546i-1 can detect and enhance may be detected based on the smallest distance between two adjacent sound sensors 210 when d in the equation (1) is distance 212—by inputting the distance 212 in the equation (1). Likewise, the smallest sound signal frequency that the first configuration of the microphone array 546i-1 can detect and enhance may be detected based on the largest distance between two sound sensors 210 that are furthest away from each other when d in the equation (1) is seven×distance 212—by inputting the seven×distance 212 in the equation (1).

Other distances between any two sound sensors 210 may result in detecting and enhancing respective sound signal frequencies when a respective distance between two sound sensors 210 is used in the equation (1). For example, the distance between the first and third sound sensors 210 from the left (i.e., 2×distance 212), the distance between the first and fourth sound sensors 210 from the left (i.e., 3×distance 212), the distance between the first and fifth sound sensors 210 from the left (i.e., 4×distance 212), the distance between the first and sixth sound sensors from the left (i.e., 5×distance 212), and the distance between the first and seventh sound sensors from the left (i.e., 6×distance 212), and any other distance between any two sound sensors 210 may result in detecting and enhancing respective sound signal frequencies when a respective distance between two sound sensors 210 is used in the equation (1).

In certain embodiments, the order of enhancement of a sound signal frequency may depend on the number of instances that two sound sensors 210 have a distance that is associated with the sound signal frequency. In the illustrated example, the largest sound signal frequency calculated using the distance 212 in the equation (1) is repeated seven times because there are seven pairs of adjacent sound sensors 210 that each have the distance 212 (i.e., the smallest distance) between them. Therefore, in the illustrated example of first configuration of the microphone array 546i-1, the order of enhancement of the largest sound signal frequency is seven. Similarly, the smallest sound signal frequency calculated using the largest distance between two sound sensors 210 in the equation (1) is repeated one time because there is only one pair of sound sensors 210 with the distance seven×distance 212 (i.e., the largest distance) between them. Therefore, in the illustrated example of the first configuration of the microphone array 546i-1, the order of enhancement of the smallest sound signal frequency is one. Likewise, other sound signal frequencies may be enhanced according to their number of repetitions/instances of pairs of sound sensors 210 with respective distances.

The arrangement of the first configuration of the microphone array 546i-1 may allow the first configuration of the microphone array 546i-1 to detect and enhance sound signals coming from the front and behind the autonomous vehicle 502. The sound signals coming from other directions may not be enhanced and may be disregarded or filtered.

The first configuration of the microphone array 546i-1 may provide detection of a wider range of sound signal frequencies compared to other configurations of the microphone array 546i-3 and 4 due to at least the large difference between the smallest distance 212 and the largest distance (i.e., seven×distance 212) in the first configuration of the microphone array 546i-1.

The first configuration of the microphone array 546i-1 may provide a lower frequency resolution range detection compared to other configurations of the microphone array 546i-2 to 4 because at least all the distances between two adjacent sound sensors 210 are different in the other configurations of the microphone array 546i-2 to 4. The first configuration of the microphone array 546i-1 may provide better detection of vehicle siren and horn sounds compared to other configurations of the microphone array 546i-2 to 4.

### Second Example Configuration of the Microphone Array

As can be seen in the example of FIG. 2, the second configuration of microphone array 546i-2 is arranged in a 1D plane. The 1D plane is a plane in space that is parallel to a road traveled by the autonomous vehicle 502. The 1D plane is illustrated in FIG. 3A.

Similar to the first configuration, the second configuration of microphone array 546i-2 is arranged such that sound signals coming from azimuth angles/directions can be detected (see FIG. 3A). The arrangement of the second configuration of microphone array 546i-2 may allow the second configuration of microphone array 546i-2 to detect and enhance sound signals coming from the front and behind the autonomous vehicle 502. The sound signals coming from other directions may not be enhanced and may be disregarded or filtered.

The second configuration of microphone array 546i-2 is arranged in a non-linear array—meaning that each two adjacent sound sensors 210 are located at different distances from each other. For example, each pair of adjacent sound sensors 210 in a first subset of sound sensors 210a may be located at a distance (d2) 214 from each other, and each pair of adjacent sound sensors 210 in a second subset of sound sensors 210b may be located at a different (d1) 212 from each other. The distance 214 may be 1 cm, for example. In other examples, the distance 214 may be any suitable value.

In the illustrated example, the second configuration of microphone array 546i-2 includes eight sound sensors 210. In other examples, the second configuration of microphone array 546i-2 may include any suitable number of sound sensors 210.

Similar to that described with respect to the first configuration of the microphone array 546i-1, in certain embodiments, the sound signal frequency range(s) that the second configuration of microphone array 546i-2 is configured to detect and enhance is determined based on the distances between each pair of sound sensors 210 which can be calculated using the equation (1).

The highest sound signal frequency that the second configuration of microphone array 546i-2 can detect and enhance may be detected based on the smallest distance between two adjacent sound sensors 210 when d in the equation (1) is distance 214. Likewise, the smallest sound signal frequency that the second configuration of microphone array 546i-2 can detect and enhance may be detected based on the largest distance between two sound sensors 210 that are furthest away from each other (i.e., the distance between the sound sensors at two opposite ends of the second configuration of microphone array 546i-2). Other distances between any two sound sensors 210 may result in detecting and enhancing respective sound signal frequencies when a respective distance between two sound sensors 210 is used in the equation (1).

The various distances 212 and 214 (and their variations and multiplications) in the second configuration of microphone array 546i-2 lead to the detection a higher sound signal frequency resolution compared to the first configuration of the microphone array 546i-1. In certain embodiments, the order of enhancement of a sound signal frequency may depend on the number of instances that two sound sensors 210 have a distance that is associated with the sound signal frequency.

In the illustrated example, the largest sound signal frequency calculated using the distance 214 in the equation (1) is repeated four times because there are four pairs of adjacent sound sensors 210 that each have the distance 214 (i.e., the smallest distance) between them. Therefore, in the illustrated example of the second configuration on the microphone array 546i-2, the order of enhancement of the largest sound signal frequency is four. Similarly, the smallest sound signal frequency calculated using the largest distance between two sound sensors 210 in the equation (1) is repeated one time because there is only one pair of sound sensors 210 with the largest distance between them (i.e., two sensors on the opposite ends). Therefore, in the illustrated example of the second configuration on the microphone array 546i-2, the order of enhancement of the smallest sound signal frequency is one. Likewise, other sound signal frequencies may be enhanced according to their number of repetitions/instances of pairs of sound sensors 210 with respective distances.

The second configuration of microphone array 546i-2 may provide detection of a wider sound signal frequency range and high sound signal frequency resolution compared to the other configurations of the microphone array 546i.

### Third Example Configuration of the Microphone Array

As can be seen in the example of FIG. 2, the third configuration of microphone array 546i-3 is arranged in a two-dimensional (2D) plane in two rows. In the illustrated example, a first subset 216 of sound sensors 210 of the third configuration of microphone array 546i-3 are arranged in a first row of the two rows, and a second subset 218 of sound sensors 210 of the third configuration of microphone array 546i-3 are arranged in a second row of the two rows.

In the illustrated example, the first subset 216 of sound sensors 210 are arranged in a linear array such that each two adjacent sound sensors 210 are located at a particular distance (d1) 212 from each other. Similarly, in the illustrated example, the second subset 218 of sound sensors 210 are arranged in a linear array such that each two adjacent sound sensors 210 are located at a particular distance (d1) 212 from each other.

The arrangement of the third configuration of the microphone array 546i-3 may allow the third configuration of the microphone array 546i-3 to detect and enhance sound signals coming from the front, behind, above, and below the autonomous vehicle 502. The sound signals coming from other directions may not be enhanced and may be disregarded or filtered.

Referring to FIG. 3A, the third configuration of the microphone array 546i-3 may be able to detect and enhance sound signals coming from azimuth angles/directions and elevation angles/directions. The azimuth angels/directions may refer to the directions from the front of and behind the autonomous vehicle 502, and the elevation angles/directions may refer to above and below the autonomous vehicle 502.

Referring back to FIG. 2, in the illustrated example, the third configuration of the microphone array 546i-3 includes nine sound sensors 210. In other examples, the third configuration of the microphone array 546i-3 may include any suitable number of sound sensors 210, and may be arranged in any suitable configuration.

In certain embodiments, the sound signal frequency range(s) that the third configuration of the microphone array 546i-3 is configured to detect and enhance is determined based on the distances between each pair of sound sensors 210 which can be calculated using the equation (1). The highest sound signal frequency that the third configuration of the microphone array 546i-3 can detect and enhance may be detected based on the smallest distance between two adjacent sound sensors 210 when d in the equation (1) is distance 212. Likewise, the smallest sound signal frequency that the third configuration of the microphone array 546i-3 can detect and enhance may be detected based on the largest distance between two sound sensors 210 that are furthest away from each other (i.e., the distance between the sound sensors at two opposite ends of the second subset 218 of sound sensors 210 of the third configuration of the microphone array 546i-3). Other distances between any two sound sensors 210 may result in detecting and enhancing respective sound signal frequencies when a respective distance between two sound sensors 210 is used in the equation (1).

The order of enhancement of the detected sound signal frequencies may be determined based on the number of instances of each pair of sound sensors 210 with respective distance 212 (and its multiplications), similar to that described above with respect to the order of enhancement of the detected sound signal frequencies by the first configuration of the microphone array 546i-1.

The third configuration of the microphone array 546i-3 may provide detection of a narrower sound signal frequency range and medium sound signal frequency resolution compared to the other configurations of the microphone array 546i-1 and 2.

### Fourth Example Configuration of the Microphone Array

As can be seen in the example of FIG. 2, the fourth configuration of the microphone array 546i-4 is arranged in a 2D plane in two rows. In the illustrated example, a first subset 220 of sound sensors 210 of the fourth configuration of the microphone array 546i-4 are arranged in a first row of the two rows, and the second subset 222 of the sound sensors 210 of the fourth configuration of the microphone array 546i-4 are arranged in a second row of the two rows.

In the illustrated example, the first subset 220 of sound sensors 210 of the fourth configuration of the microphone array 546i-4 are arranged in a non-linear array such that the pairs of adjacent sound sensors 210 are separated by various distances—i.e., distance 212 and two×distance 212. Similarly, the second subset 222 of sound sensors 210 of the fourth configuration of the microphone array 546i-4 are arranged in a non-linear array such that the pairs of adjacent sound sensors 210 are separated by various distances—i.e., distance 212 and two×distance 212.

The arrangement of the fourth configuration of the microphone array 546i-4 may allow the fourth configuration of the microphone array 546i-4 to detect and enhance sound signals coming from the front, behind, above, and below the autonomous vehicle 502. The sound signals coming from other directions may not be enhanced and may be disregarded or filtered. Referring to FIG. 3A, the fourth configuration of the microphone array 546i-4 may be able to detect and enhance sound signals coming from azimuth angles/directions and elevation angles/directions.

Referring back to FIG. 2, in the illustrated example, the fourth configuration of the microphone array 546i-4 includes eight sound sensors 210. In other examples, the fourth configuration of the microphone array 546i-4 may include any suitable number of sound sensors 210, and may be arranged in any suitable configuration.

In certain embodiments, the sound signal frequency range(s) that the fourth configuration of the microphone array 546i-4 is configured to detect and enhance is determined based on the distances between each pair of sound sensors 210 which can be calculated using the equation (1). The highest sound signal frequency that the fourth configuration of the microphone array 546i-4 can detect and enhance may be detected based on the smallest distance between two adjacent sound sensors 210 when d in the equation (1) is distance 212. Likewise, the smallest sound signal frequency that the fourth configuration of the microphone array 546i-4 can detect and enhance may be detected based on the largest distance between two sound sensors 210 that are furthest away from each other (i.e., the distance between the sound sensors at two opposite ends of the subset 220 or 222 of sound sensors 210 of the fourth configuration of the microphone array 546i-4). Other distances between any two sound sensors 210 may result in detecting and enhancing respective sound signal frequencies when a respective distance between two sound sensors 210 is used in the equation (1).

The order of enhancement of the detected sound signal frequencies may be determined based on the number of instances of each pair of sound sensors 210 with respective distance 212 (and its multiplications), similar to that described above with respect to the order of enhancement of the detected sound signal frequencies by the first configuration of the microphone array 546i-1.

The fourth configuration of the microphone array 546i-4 may provide detection of a narrower sound signal frequency range and medium sound signal frequency resolution compared to the other configurations of the microphone array 546i-1 and 2.

One aim of the microphone array 546i may be to detect and enhance several sounds including sirens, horns, rumble strips, and rain. Table 1 summarizes the ranking of the four configurations of the microphone array 546i-1 to 4 regarding their performance for detecting sirens, horns, rumble strips, and rain compared to one another. Table 1 also summarizes the direction of arrival (DOA) of sounds that can be detected and enhanced, and the frequency ranges of sound signals that can be detected and enhanced.

TABLE 1
Various microphone array configurations performance

| | | | | | Rumble | |
|---|---|---|---|---|---|---|
| Microphone | | Frequency | Siren | Horn | strip | Rain |
| array 546i | DOA | range | detection | detection | detection | detection |
| 546i-1 | 1D | Wide | Best | Best | Good | Normal |
| | | frequency | | | | |
| | | range; low | | | | |
| | | frequency | | | | |
| | | resolution | | | | |
| 546i-2 | 1D | Wide | Better | Good | Normal | Best |
| | | frequency | | | | |
| | | range; low | | | | |
| | | frequency | | | | |
| | | resolution | | | | |
| 546i-3 | 2D | Narrow | Normal | Normal | Best | Better |
| | | frequency | | | | |
| | | range; | | | | |
| | | medium | | | | |
| | | frequency | | | | |
| | | resolution | | | | |
| 546i-4 | 2D | Narrow | Good | Better | Better | Good |
| | | frequency | | | | |
| | | range; | | | | |
| | | medium | | | | |
| | | frequency | | | | |
| | | resolution | | | | |

### Operational Flow for Navigating an Autonomous Vehicle Using at Least the Microphone Array

Referring back to FIG. 1, an example operational flow of the system 100 for navigating an autonomous vehicle 502 using at least the microphone array 546i is described below. When the autonomous vehicle 502 and the control device 550 are operational, the sensors 546 (including the microphone array 546i) may also be activated or become operational. In an example scenario, while the autonomous vehicle 502 is traveling along the road 102, the sensors 546 capture sensor data 130 and communicate it to the control device 550 for processing. For example, with respect to the microphone array 546i, the microphone array 546i may detect sound signals 112a-b. Each sound signals 112a-b may be originated from a particular sound source 104a-b. Examples of the sound sources 104a-b may include vehicles, wind, rain, pedestrians, rumble strips, vehicle tires, vehicle engines, objects on and around the road 102, and any other entity.

In the illustrated example, assume that the first sound signals 112a are originated from sound sources 104a that include passenger vehicles, emergency vehicles (e.g., law enforcement vehicles, medical vehicles, fire trucks, and the like), motorcycles, bicycles, buses, trains, and the like. The first sound signals 112a may include an emergency vehicle siren (e.g., law enforcement and medical vehicle sirens), passenger vehicle horn, bus horn, train horn, and the like. The first sound signals 112a may include sound signals 112a-1 and 112a-2.

Also assume that the second sound signals 112b are originated from sound sources 104b that include wind, rain, vehicle tiers, vehicle engines, and other sources. Thus, the second sound signals 112b may include a rainfall sound, a wind sound, a vehicle tire sound, or a rumble strip sound. Each of the sound signals 112a-b may have a particular frequency band. For example, the sound signal 112a-1 may have a first frequency band, the sound signal 112a-2 may have a second frequency band, and the sound signal 112b may have a third frequency band.

### Processing the Detected Sound Signals

In certain embodiments, upon detecting the sound signals 112a-b, the microphone array 546i may communicate the sound signals 112a-b to the sound signal processing device 140. The sound signal processing device 140 may receive the sound signals 112a-b and process them. The sound signal processing device 140 may separate each sound signal 112a-b from others, e.g., using a band pass filter, a low pass filter, and/or a high pass filter, similar to that described in FIG. 1.

The sound signal processing device 140 may amplify the sound signals 112a each with a different enhancement or amplification order 114a, similar to that described in FIG. 2. For example, the sound signal processing device 140 may amplify the sound signal 112a-1 with a first amplification order 114a-1—producing the amplified sound signal 112a-1. Similarly, the sound signal processing device 140 may amplify the sound signal 112a-2 with a second amplification order 114a-2—producing the amplified sound signal 112a-2.

The sound signal processing device 140 may disregard (i.e., filter) the sound signals 112b, for example, using band pass filters, low pass filters, and/or high pass filters.

The components of the sound signal processing device 140 (e.g., band pass filters, low pass filters, high pass filters, digital signal processing, frequency filtering algorithms, frequency amplifying algorithms, and frequency analyzing algorithms, ADC, FFT module, IFFT module, among others) may be tuned and configured to filter out interference noise signals (included in the sound signals 112b) and pass and amplify sound signals of interest for navigating the autonomous vehicle 502 (i.e., the sound signals 112a).

The sound signal processing device 140 may output the amplified sound signals 112a-b to the control device 550 to be used for navigating the autonomous vehicle 502, detecting objects, detecting sound sources 104a-b, etc. In certain embodiments, the sound signal processing device 140 may also output sound signals 112b to the control device 550. However, the sound signals 112b may be associated with signal frequencies that are known to be noise or interference signals. Therefore, the control device 550 may not use or account for the sound signals 112b in navigating the autonomous vehicle 502.

The control device 550 may use a training dataset that includes sound data samples each labeled with a respective sound source. The control device 550 may implement the object detection machine learning module 132 to detect the sound sources 104a-b. In this process, the control device 550 may extract features from each received sound signal 112a-b. The extracted features may indicate the respective sound source 104a-b. Each set of extracted features may be represented by a feature vector comprising numerical values. The control device 550 may compare the feature vector with each vector associated with the sound data samples included in the training dataset. The control device 550 may determine a Euclidean distance between the determined feature vector and each feature vector associated with the sound sample data included in the training dataset. If the Euclidean distance between the determined feature vector and a particular feature vector is less than a threshold distance (e.g., less than 1%, 2%, etc.), it is determined that a particular sound sample data may match or correspond to the received sound signal 112a-b. Therefore, the control device 550 may also determine that the sound source 104a-b of the detected sound signal 112a-b is the same sound source that is the label of the identified sound data sample.

### Navigating the Autonomous Vehicle Using at Least the Sound Signals of Interest

As mentioned above, the control device 550 may use the sensor data 130 to determine a safe pathway for the autonomous vehicle 502 to travel. The sound data 130 may include the amplified sound signals 112a-b.

The control device 550 may determine that the sound signals 112a indicate that a vehicle 106 is within a threshold distance 108 from the autonomous vehicle 502 and traveling in a direction toward the autonomous vehicle 502. In this process, the control device 550 may determine that the sound signal 112a is getting louder. Thus, the control device 550 may determine the speed, location, and trajectory of the vehicle 106. Since the sound signals 112a are amplified and sound signals 112b are filtered (i.e., disregarded), the detection of the speed, location, and trajectory of the vehicle 106 has become less complex compared to the current technology. In certain embodiments, where the first configuration of microphone array 546i-1 (see FIG. 2) is implemented, only sound signals 112a coming from the front of and behind the autonomous vehicle 502 are amplified, and other sound signals are disregarded. For example, the control device 550 may determine that the vehicle 106 is an emergency vehicle whose sirens are on—instructing the vehicles on the road 102 to move aside or stop to allow the emergency vehicle to pass.

In response, the control device 550 may instruct the autonomous vehicle 502 to perform an MRC operation 150. The MRC operation 150 may include pulling the autonomous vehicle 502 over to a side of the road 102, stopping the autonomous vehicle 502 without hindering the traffic, and the like. In this manner, the control device 550 may facilitate the autonomous driving of the autonomous vehicle 502 using at least the sound signals 112a, where the autonomous driving of the autonomous vehicle 502 is improved in response to disregarding the sound signals 112b that include noises and other sounds that are not of interest for navigating the autonomous vehicle 502.

In certain embodiments, the control device 550 may determine that the autonomous vehicle 502 is traveling on rumble strips based on the sound signals 112a-b. This may be due to at least the preset configurations of the sound signal processing device 140 that is configured to detect the sound when the autonomous vehicle 502 is traveling over rumble strips. In response, the control device 550 may instruct the autonomous vehicle 502 to slow down.

The use of sound signals 112a-b in detecting the autonomous vehicle 502 traveling on the rumble strips may be instead of or in addition to the use of images captured by cameras (546a in FIG. 5), and other data types, including Radar data, point cloud data, etc., detected by other types of sensor 546. For example, in cases where one or more types of sensors 546 are not operational, the microphone array 546i may be given priority to detect objects, their trajectories, types, locations, and other characteristics of objects and conditions on the road 102.

In certain embodiments, the control device 550 may determine that one or more vehicles in front of the autonomous vehicle 502 are traveling over rumble strips based on the sound signals 112a-b. In response, the control device 550 may instruct the autonomous vehicle 502 to slow down before it reaches the rumble strips. Similar operations of the control device 550 may apply in cases of vehicles in front of the autonomous vehicle 502 going over speed bumps, debris, puddles, etc.

In certain embodiments, the control device 550 may determine that the autonomous vehicle 502 is unintentionally going outside of a road lane based on determining that sound signals 112a-b include sounds that indicate the autonomous vehicle 502 is moving on lane separators. In other words, the autonomous vehicle 502 may determine that the autonomous vehicle 502 is traveling off-center and at least one tire of the autonomous vehicle 502 is going outside of the current lane. In response, the control device 550 may instruct the autonomous vehicle 502 to steer back to the center of the lane. This is particularly useful if one or more other sensors 546 are not operational or do not detect that the autonomous vehicle 502 is unintentionally going outside of the current lane.

In certain embodiments, the control device 550 may detect a human's voice, e.g., when the human is standing next to the autonomous vehicle 502 or within a threshold distance 108 from the autonomous vehicle 502. For example, the control device 550 may detect verbal instructions of the human instructing the autonomous vehicle 502 to perform actions, e.g., stop, pull over, and the like.

FIG. 3A illustrates an isometric view of an autonomous vehicle 502 with planar structures showing directions of arrivals of sound signals toward the autonomous vehicle 502. The first and second configurations of the microphone array 546i-1 and 2 are configured to detect and enhance sound signals with particular frequencies in azimuth angles/directions, and the third and fourth configurations of the microphone array 546i-3 and 4 are configured to detect and enhance sound signals with particular frequencies in azimuth and elevation angles/directions, similar to that described in FIG. 2.

FIG. 3B illustrates an example location for mounting the microphone array 546i. The location for mounting the microphone array 546i may be determined such that the least noise (e.g., from wind and autonomous vehicle engine) and lease difference in air pressure are observed in wind noise and air pressure detection simulations in that location.

### Example Method for Navigating the Autonomous Vehicle Using at Least Detected Sound Signals

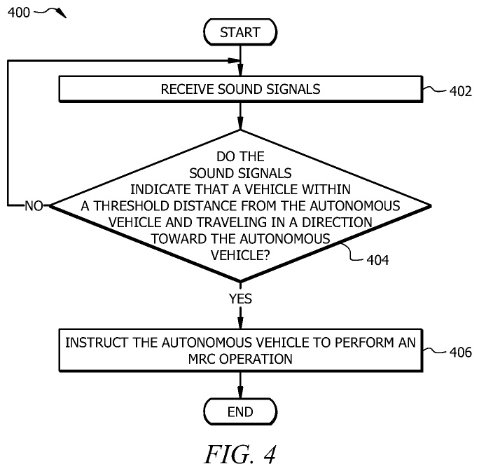

FIG. 4 illustrates an example flowchart of a method 400 for navigating the autonomous vehicle using at least detected sound signals. Modifications, additions, or omissions may be made to method 400. Method 400 may include more, fewer, or other operations. For example, operations may be performed in parallel or in any suitable order. While at times discussed as the autonomous vehicle 502, control device 550, sound signal processing device 140, or components of any of thereof performing operations, any suitable system or components of the system may perform one or more operations of the method 400. For example, one or more operations of method 400 may be implemented, at least in part, in the form of software instructions 128, sound signal processing instructions 148, and processing instructions 580, respectively, from FIGS. 1 and 5, stored on non-transitory, tangible, machine-readable media (e.g., memory 126, memory 146, and data storage 590, respectively, from FIGS. 1 and 5) that when run by one or more processors (e.g., processors 122, 142 and 570, respectively, from FIGS. 1 and 5) may cause the one or more processors to perform operations 402-406.

Method 400 begins at operation 402 when the control device 550 receives sound signals 112a-b. In this operation, the control device 550 may receive sound signals 112a-b from the sound signal processing device 140, where the sound signals 112a-b are detected by the microphone array 546i, similar to that described in FIGS. 1 and 2. The sound signals 112a may be amplified and the sound signals 112b may be disregarded, similar to that described in FIGS. 1 and 2. The control device may also receive sensor data 130 from the sensors 546.

At operation 404, the control device 550 may determine whether the sound signals 112a indicate that a vehicle 106 is within the threshold distance 108 from the autonomous vehicle 502 and traveling in a direction toward the autonomous vehicle 502. For example, the control device 550 may determine that the vehicle 106 is an emergency vehicle whose sirens are on—instructing the vehicles on the road 102 to move aside or stop to allow the emergency vehicle to pass.

At operation 406, the control device 550 instructs the autonomous vehicle 502 to perform the MRC operation 150, such as pulling over or stopping without hindering the traffic. In some embodiments, if the control device 550 determines that a vehicle 106's horn is making a sound, the control device 550 may slow the autonomous vehicle 502 down until the vehicle 106 passes the autonomous vehicle 502.

### Example Autonomous Vehicle and its Operation

FIG. 5 shows a block diagram of an example vehicle ecosystem 500 in which autonomous driving operations can be determined. As shown in FIG. 5, the autonomous vehicle 502 may be a semi-trailer truck. The vehicle ecosystem 500 may include several systems and components that can generate and/or deliver one or more sources of information/data and related services to the in-vehicle control computer 550 that may be located in an autonomous vehicle 502. The in-vehicle control computer 550 can be in data communication with a plurality of vehicle subsystems 540, all of which can be resident in the autonomous vehicle 502. A vehicle subsystem interface 560 may be provided to facilitate data communication between the in-vehicle control computer 550 and the plurality of vehicle subsystems 540. In some embodiments, the vehicle subsystem interface 560 can include a controller area network (CAN) controller to communicate with devices in the vehicle subsystems 540.

The autonomous vehicle 502 may include various vehicle subsystems that support the operation of the autonomous vehicle 502. The vehicle subsystems 540 may include a vehicle drive subsystem 542, a vehicle sensor subsystem 544, a vehicle control subsystem 548, and/or network communication subsystem 592. The components or devices of the vehicle drive subsystem 542, the vehicle sensor subsystem 544, and the vehicle control subsystem 548 shown in FIG. 5 are examples. The autonomous vehicle 502 may be configured as shown or any other configurations.

The vehicle drive subsystem 542 may include components operable to provide powered motion for the autonomous vehicle 502. In an example embodiment, the vehicle drive subsystem 542 may include an engine/motor 542a, wheels/tires 542b, a transmission 542c, an electrical subsystem 542d, and a power source 542e.

The vehicle sensor subsystem 544 may include a number of sensors 546 configured to sense information about an environment or condition of the autonomous vehicle 502. The vehicle sensor subsystem 544 may include one or more cameras 546a or image capture devices, a radar unit 546b, one or more thermal sensors 546c, a wireless communication unit 546d (e.g., a cellular communication transceiver), an inertial measurement unit (IMU) 546e, a laser range finder/LiDAR unit 546f, a Global Positioning System (GPS) transceiver 546g, a wiper control system 546h, and microphone array 546i. The vehicle sensor subsystem 544 may also include sensors configured to monitor internal systems of the autonomous vehicle 502 (e.g., an 02 monitor, a fuel gauge, an engine oil temperature, etc.).

The IMU 546e may include any combination of sensors (e.g., accelerometers and gyroscopes) configured to sense position and orientation changes of the autonomous vehicle 502 based on inertial acceleration. The GPS transceiver 546g may be any sensor configured to estimate a geographic location of the autonomous vehicle 502. For this purpose, the GPS transceiver 546g may include a receiver/transmitter operable to provide information regarding the position of the autonomous vehicle 502 with respect to the Earth. The radar unit 546b may represent a system that utilizes radio signals to sense objects within the local environment of the autonomous vehicle 502. In some embodiments, in addition to sensing the objects, the radar unit 546b may additionally be configured to sense the speed and the heading of the objects proximate to the autonomous vehicle 502. The laser range finder or LiDAR unit 546f may be any sensor configured to use lasers to sense objects in the environment in which the autonomous vehicle 502 is located. The cameras 546a may include one or more devices configured to capture a plurality of images of the environment of the autonomous vehicle 502. The cameras 546a may be still image cameras or motion video cameras.

Cameras 546a may be rear-facing and front-facing so that pedestrians, and any hand signals made by them or signs held by pedestrians, may be observed from all around the autonomous vehicle. These cameras 546a may include video cameras, cameras with filters for specific wavelengths, as well as any other cameras suitable to detect hand signals, hand-held traffic signs, or both hand signals and hand-held traffic signs. A sound detection array, such as the microphone array 546i, may be included in the vehicle sensor subsystem 544. The microphone array 546i may be configured to receive audio indications of the presence of, or instructions from, authorities, including sirens and commands such as “Pull over.” These microphones are mounted, or located, on the external portion of the vehicle, specifically on the outside of the tractor portion of an autonomous vehicle. Microphones used may be any suitable type, mounted such that they are effective both when the autonomous vehicle is at rest, as well as when it is moving at normal driving speeds.

The vehicle control subsystem 548 may be configured to control the operation of the autonomous vehicle 502 and its components. Accordingly, the vehicle control subsystem 548 may include various elements such as a throttle and gear selector 548a, a brake unit 548b, a navigation unit 548c, a steering system 548d, and/or an autonomous control unit 548e. The throttle and gear selector 548a may be configured to control, for instance, the operating speed of the engine and, in turn, control the speed of the autonomous vehicle 502. The throttle and gear selector 548a may be configured to control the gear selection of the transmission. The brake unit 548b can include any combination of mechanisms configured to decelerate the autonomous vehicle 502. The brake unit 548b can slow the autonomous vehicle 502 in a standard manner, including by using friction to slow the wheels or engine braking. The brake unit 548b may include an anti-lock brake system (ABS) that can prevent the brakes from locking up when the brakes are applied. The navigation unit 548c may be any system configured to determine a driving path or route for the autonomous vehicle 502. The navigation unit 548c may additionally be configured to update the driving path dynamically while the autonomous vehicle 502 is in operation. In some embodiments, the navigation unit 548c may be configured to incorporate data from the GPS transceiver 546g and one or more predetermined maps so as to determine the driving path for the autonomous vehicle 502. The steering system 548d may represent any combination of mechanisms that may be operable to adjust the heading of autonomous vehicle 502 in an autonomous mode or in a driver-controlled mode.

The autonomous control unit 548e may represent a control system configured to identify, evaluate, and avoid or otherwise negotiate potential obstacles or obstructions in the environment of the autonomous vehicle 502. In general, the autonomous control unit 548e may be configured to control the autonomous vehicle 502 for operation without a driver or to provide driver assistance in controlling the autonomous vehicle 502. In some embodiments, the autonomous control unit 548e may be configured to incorporate data from the GPS transceiver 546g, the radar unit 546b, the LiDAR unit 546f, the cameras 546a, and/or other vehicle subsystems to determine the driving path or trajectory for the autonomous vehicle 502.

The network communication subsystem 592 may comprise network interfaces, such as routers, switches, modems, and/or the like. The network communication subsystem 592 may be configured to establish communication between the autonomous vehicle 502 and other systems, servers, etc. The network communication subsystem 592 may be further configured to send and receive data from and to other systems.

Many or all of the functions of the autonomous vehicle 502 can be controlled by the in-vehicle control computer 550. The in-vehicle control computer 550 may include at least one data processor 570 (which can include at least one microprocessor) that executes processing instructions 580 stored in a non-transitory computer-readable medium, such as the data storage device 590 or memory. The in-vehicle control computer 550 may also represent a plurality of computing devices that may serve to control individual components or subsystems of the autonomous vehicle 502 in a distributed fashion. In some embodiments, the data storage device 590 may contain processing instructions 580 (e.g., program logic) executable by the data processor 570 to perform various methods and/or functions of the autonomous vehicle 502, including those described with respect to FIGS. 1-7.

The data storage device 590 may contain additional instructions as well, including instructions to transmit data to, receive data from, interact with, or control one or more of the vehicle drive subsystem 542, the vehicle sensor subsystem 544, and the vehicle control subsystem 548. The in-vehicle control computer 550 can be configured to include a data processor 570 and a data storage device 590. The in-vehicle control computer 550 may control the function of the autonomous vehicle 502 based on inputs received from various vehicle subsystems (e.g., the vehicle drive subsystem 542, the vehicle sensor subsystem 544, and the vehicle control subsystem 548).

FIG. 6 shows an exemplary system 600 for providing precise autonomous driving operations. The system 600 may include several modules that can operate in the in-vehicle control computer 550, as described in FIG. 5. The in-vehicle control computer 550 may include a sensor fusion module 602 shown in the top left corner of FIG. 6, where the sensor fusion module 602 may perform at least four image or signal processing operations. The sensor fusion module 602 can obtain images from cameras located on an autonomous vehicle to perform image segmentation 604 to detect the presence of moving objects (e.g., other vehicles, pedestrians, etc.) and/or static obstacles (e.g., stop sign, speed bump, terrain, etc.) located around the autonomous vehicle. The sensor fusion module 602 can obtain LiDAR point cloud data item from LiDAR sensors located on the autonomous vehicle to perform LiDAR segmentation 606 to detect the presence of objects and/or obstacles located around the autonomous vehicle.

The sensor fusion module 602 can perform instance segmentation 608 on image and/or point cloud data items to identify an outline (e.g., boxes) around the objects and/or obstacles located around the autonomous vehicle. The sensor fusion module 602 can perform temporal fusion 610 where objects and/or obstacles from one image and/or one frame of point cloud data item are correlated with or associated with objects and/or obstacles from one or more images or frames subsequently received in time.

The sensor fusion module 602 can fuse the objects and/or obstacles from the images obtained from the camera and/or point cloud data item obtained from the LiDAR sensors. For example, the sensor fusion module 602 may determine based on a location of two cameras that an image from one of the cameras comprising one half of a vehicle located in front of the autonomous vehicle is the same as the vehicle captured by another camera. The sensor fusion module 602 may send the fused object information to the tracking or prediction module 646 and the fused obstacle information to the occupancy grid module 660. The in-vehicle control computer may include the occupancy grid module 660 which can retrieve landmarks from a map database 658 stored in the in-vehicle control computer. The occupancy grid module 660 can determine drivable areas and/or obstacles from the fused obstacles obtained from the sensor fusion module 602 and the landmarks stored in the map database 658. For example, the occupancy grid module 660 can determine that a drivable area may include a speed bump obstacle.

As shown in FIG. 6 below the sensor fusion module 602, the in-vehicle control computer 550 may include a LiDAR-based object detection module 612 that can perform object detection 616 based on point cloud data item obtained from the LiDAR sensors 614 located on the autonomous vehicle. The object detection 616 technique can provide a location (e.g., in 3D world coordinates) of objects from the point cloud data item. Below the LiDAR-based object detection module 612, the in-vehicle control computer may include an image-based object detection module 618 that can perform object detection 624 based on images obtained from cameras 620 located on the autonomous vehicle. For example, the object detection 618 technique can employ a deep image-based object detection 624 (e.g., a machine learning technique) to provide a location (e.g., in 3D world coordinates) of objects from the image provided by the camera 620.

The radar 656 on the autonomous vehicle can scan an area surrounding the autonomous vehicle or an area towards which the autonomous vehicle is driven. The radar data may be sent to the sensor fusion module 602 that can use the radar data to correlate the objects and/or obstacles detected by the radar 656 with the objects and/or obstacles detected from both the LiDAR point cloud data item and the camera image. The radar data also may be sent to the tracking or prediction module 646 that can perform data processing on the radar data to track objects by object tracking module 648 as further described below.

The in-vehicle control computer may include a tracking or prediction module 646 that receives the locations of the objects from the point cloud and the objects from the image, and the fused objects from the sensor fusion module 602. The tracking or prediction module 646 also receives the radar data with which the tracking or prediction module 646 can track objects by object tracking module 648 from one point cloud data item and one image obtained at one time instance to another (or the next) point cloud data item and another image obtained at another subsequent time instance.

The tracking or prediction module 646 may perform object attribute estimation 650 to estimate one or more attributes of an object detected in an image or point cloud data item. The one or more attributes of the object may include a type of object (e.g., pedestrian, car, or truck, etc.). The tracking or prediction module 646 may perform behavior prediction 652 to estimate or predict the motion pattern of an object detected in an image and/or a point cloud. The behavior prediction 652 can be performed to detect a location of an object in a set of images received at different points in time (e.g., sequential images) or in a set of point cloud data items received at different points in time (e.g., sequential point cloud data items). In some embodiments, the behavior prediction 652 can be performed for each image received from a camera and/or each point cloud data item received from the LiDAR sensor. In some embodiments, the tracking or prediction module 646 can be performed (e.g., run or executed) on received data to reduce computational load by performing behavior prediction 652 on every other or after every pre-determined number of images received from a camera or point cloud data item received from the LiDAR sensor (e.g., after every two images or after every three-point cloud data items).

The behavior prediction 652 feature may determine the speed and direction of the objects that surround the autonomous vehicle from the radar data, where the speed and direction information can be used to predict or determine motion patterns of objects. A motion pattern may comprise a predicted trajectory information of an object over a pre-determined length of time in the future after an image is received from a camera. Based on the motion pattern predicted, the tracking or prediction module 646 may assign motion pattern situational tags to the objects (e.g., “located at coordinates (x,y),” “stopped,” “driving at 50 mph,” “speeding up” or “slowing down”). The situation tags can describe the motion pattern of the object. The tracking or prediction module 646 may send the one or more object attributes (e.g., types of the objects) and motion pattern situational tags to the planning module 662. The tracking or prediction module 646 may perform an environment analysis 654 using any information acquired by system 600 and any number and combination of its components.

The in-vehicle control computer may include the planning module 662 that receives the object attributes and motion pattern situational tags from the tracking or prediction module 646, the drivable area and/or obstacles, and the vehicle location and pose information from the fused localization module 626 (further described below).

The planning module 662 can perform navigation planning 664 to determine a set of trajectories on which the autonomous vehicle can be driven. The set of trajectories can be determined based on the drivable area information, the one or more object attributes of objects, the motion pattern situational tags of the objects, location of the obstacles, and the drivable area information. In some embodiments, the navigation planning 664 may include determining an area next to the road where the autonomous vehicle can be safely parked in a case of emergencies. The planning module 662 may include behavioral decision making 666 to determine driving actions (e.g., steering, braking, throttle) in response to determining changing conditions on the road (e.g., traffic light turned yellow, or the autonomous vehicle is in an unsafe driving condition because another vehicle drove in front of the autonomous vehicle and in a region within a pre-determined safe distance of the location of the autonomous vehicle). The planning module 662 performs trajectory generation 668 and selects a trajectory from the set of trajectories determined by the navigation planning operation 664. The selected trajectory information may be sent by the planning module 662 to the control module 670.

The in-vehicle control computer may include a control module 670 that receives the proposed trajectory from the planning module 662 and the autonomous vehicle location and pose from the fused localization module 626. The control module 670 may include a system identifier 672. The control module 670 can perform a model-based trajectory refinement 674 to refine the proposed trajectory. For example, the control module 670 can apply filtering (e.g., Kalman filter) to make the proposed trajectory data smooth and/or to minimize noise. The control module 670 may perform the robust control 676 by determining, based on the refined proposed trajectory information and current location and/or pose of the autonomous vehicle, an amount of brake pressure to apply, a steering angle, a throttle amount to control the speed of the vehicle, and/or a transmission gear. The control module 670 can send the determined brake pressure, steering angle, throttle amount, and/or transmission gear to one or more devices in the autonomous vehicle to control and facilitate precise driving operations of the autonomous vehicle.

The deep image-based object detection 624 performed by the image-based object detection module 618 can also be used detect landmarks (e.g., stop signs, speed bumps, etc.) on the road. The in-vehicle control computer may include a fused localization module 626 that obtains landmarks detected from images, the landmarks obtained from a map database 636 stored on the in-vehicle control computer, the landmarks detected from the point cloud data item by the LiDAR-based object detection module 612, the speed and displacement from the odometer sensor 644, or a rotary encoder, and the estimated location of the autonomous vehicle from the GPS/IMU sensor 638 (i.e., GPS sensor 640 and IMU sensor 642) located on or in the autonomous vehicle. Based on this information, the fused localization module 626 can perform a localization operation 628 to determine a location of the autonomous vehicle, which can be sent to the planning module 662 and the control module 670.

The fused localization module 626 can estimate pose 630 of the autonomous vehicle based on the GPS and/or IMU sensors 638. The pose of the autonomous vehicle can be sent to the planning module 662 and the control module 670. The fused localization module 626 can also estimate status (e.g., location, possible angle of movement) of the trailer unit based on (e.g., trailer status estimation 634), for example, the information provided by the IMU sensor 642 (e.g., angular rate and/or linear velocity). The fused localization module 626 may also check the map content 632.

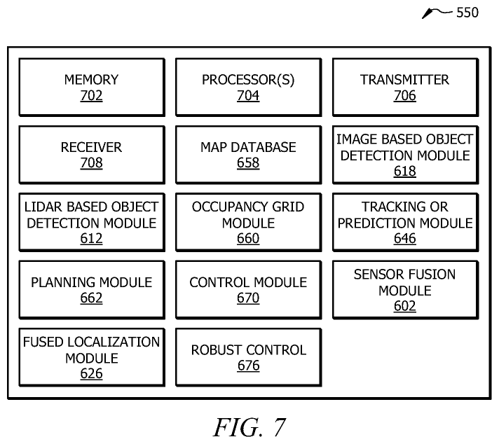

FIG. 7 shows an exemplary block diagram of an in-vehicle control computer 550 included in an autonomous vehicle 502. The in-vehicle control computer 550 may include at least one processor 704 and a memory 702 having instructions stored thereupon (e.g., software instructions 128 and processing instructions 580 in FIGS. 1 and 5, respectively). The instructions, upon execution by the processor 704, configure the in-vehicle control computer 550 and/or the various modules of the in-vehicle control computer 550 to perform the operations described in FIGS. 1-7. The transmitter 706 may transmit or send information or data to one or more devices in the autonomous vehicle. For example, the transmitter 706 can send an instruction to one or more motors of the steering wheel to steer the autonomous vehicle. The receiver 708 receives information or data transmitted or sent by one or more devices. For example, the receiver 708 receives a status of the current speed from the odometer sensor or the current transmission gear from the transmission. The transmitter 706 and receiver 708 also may be configured to communicate with the plurality of vehicle subsystems 540 and the in-vehicle control computer 550 described above in FIGS. 5 and 6.

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated into another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

Implementations of the disclosure can be described in view of the following clauses, the features of which can be combined in any reasonable manner.

Clause 1. A system comprising:
a microphone array comprising a plurality of sound sensors, wherein the microphone array is mounted on an autonomous vehicle, and configured to:
   detect one or more first sound signals from one or more first sound sources, detect one or more second sound signals from one or more second sound sources;
a processor associated with the autonomous vehicle, and configured to:
   receive the one or more first sound signals;
   receive the one or more second sound signals;
   amplify the one or more first sound signals;
   disregard the one or more second sound signals, wherein the one or more second sound signals comprise interference noise signals;
   determine that the one or more first sound signals indicate that a vehicle is within a threshold distance from the autonomous vehicle and traveling in a direction toward the autonomous vehicle; and
   instruct the autonomous vehicle to perform a minimal risk maneuver operation in response to determining that the one or more first sound signals indicate that the vehicle is within the threshold distance from the autonomous vehicle and traveling in the direction toward the autonomous vehicle.

Clause 2. The system of Clause 1, wherein the minimal risk maneuver operation comprises pulling the autonomous vehicle over to a side of a road.

Clause 3. The system of Clause 1, wherein the minimal risk maneuver operation comprises stopping the autonomous vehicle.

Clause 4. The system of Clause 1, wherein the processor is further configured to facilitate autonomous driving of the autonomous vehicle using at least the one or more first sound signals, wherein the autonomous driving of the autonomous vehicle is improved in response to disregarding the one or more second sound signals.

Clause 5. The system of Clause 1, wherein:
the one or more first sound signals comprise a first sound signal; and
amplifying the one or more first sound signals, each with a particular amplification order, comprises amplifying the first sound signal with a first amplification order.

Clause 6. The system of Clause 1, wherein:
the microphone array is arranged in a one-dimension (1D) plane;
the 1D plane is a plane in space parallel to a road travelled by the autonomous vehicle; and
the microphone array is further arranged in a uniform linear array such that each two adjacent sound sensors are disposed with a particular distance from each other.

Clause 7. The system of Clause 1, wherein:
the microphone array is arranged in a one-dimension (1D) plane;
the 1D plane is a plane in space parallel to a road travelled by the autonomous vehicle;
the microphone array is further arranged in a non-linear array such that a first subset of sound sensors are disposed with a first distance from each other and a second subset of sound sensors are disposed with a second distance from each other; and
the first distance is different from the second distance.

Clause 8. A method comprising:
receiving, from a microphone array, one or more first sound signals from one or more first sound sources;
receiving, from a microphone array, one or more second sound signals from one or more second sound sources;
amplify the one or more first sound signals;
disregarding the one or more second sound signals, wherein the one or more second sound signals comprise interference noise signals;
determining that the one or more first sound signals indicate that a vehicle is within a threshold distance from an autonomous vehicle and traveling in a direction toward the autonomous vehicle; and
instructing the autonomous vehicle to perform a minimal risk maneuver operation in response to determining that the one or more first sound signals indicate that the vehicle is within the threshold distance from the autonomous vehicle and traveling in the direction toward the autonomous vehicle.

Clause 9. The method of Clause 8, wherein:
the microphone array is arranged in a two-dimension (2D) plane and in two rows;
a first subset of sound sensors of the microphone array are arranged in a first row of the two rows;
the first subset of sound sensors of the microphone array are further arranged in a linear array such that each two adjacent sound sensors are disposed with a particular distance from each other;
a second subset of sound sensors of the microphone array are arranged in a second row of the two rows; and
the second subset of sound sensors of the microphone array are arranged in a linear array such that each two adjacent sound sensors are disposed with a particular distance from each other.

Clause 10. The method of Clause 8, wherein:
the microphone array is arranged in a two-dimension (2D) plane and in two rows;
a first subset of sound sensors of the microphone array are arranged in a first row of the two rows;
the first subset of sound sensors of the microphone array are further arranged in a non-linear array;
a second subset of sound sensors of the microphone array are arranged in a second row of the two rows; and
the second subset of sound sensors of the microphone array are further arranged in a non-linear array.

Clause 11. The method of Clause 8, wherein the one or more first sound sources comprise the vehicle or a passenger vehicle.

Clause 12. The method of Clause 8, wherein the one or more first sound signals comprise an emergency vehicle siren or a passenger vehicle horn.

Clause 13. The method of Clause 8, wherein the one or more second sound sources comprise rain, wind, or vehicle tires.

Clause 14. The method of Clause 8, wherein the one or more second sound signals comprise a rainfall sound, a wind sound, a vehicle tire sound, or a rumble strip sound.

Clause 15. A non-transitory computer-readable medium storing instructions that when executed by a processor cause the processor to:
receive, from a microphone array, one or more first sound signals from one or more first sound sources;
receive, from a microphone array, one or more second sound signals from one or more second sound sources;
amplify the one or more first sound signals;
disregard the one or more second sound signals, wherein the one or more second sound signals comprise interference noise signals;
determine that the one or more first sound signals indicate that a vehicle is within a threshold distance from an autonomous vehicle and traveling in a direction toward the autonomous vehicle; and
instruct the autonomous vehicle to perform a minimal risk maneuver operation in response to determining that the one or more first sound signals indicate that the vehicle is within the threshold distance from the autonomous vehicle and traveling in the direction toward the autonomous vehicle.

Clause 16. The non-transitory computer-readable medium of Clause 15, wherein amplifying the one or more first sound signals comprises amplifying the one or more first sound signals only coming from front of and/or back of the autonomous vehicle.

Clause 17. The non-transitory computer-readable medium of Clause 15, wherein:
each of the one or more first sound signals originate from a particular sound source from among the one or more first sound sources;
each of the one or more first sound signals has a particular frequency band;
each of the one or more second sound signals is originated from a particular sound source from among the one or more second sound sources;
the one or more second sound signals are different from the one or more first sound signals;
the one or more second sound sources are different from the one or more first sound sources; and
the instructions further cause the processor to separate the one or more second sound signals from the one or more first sound signals.

Clause 18. The non-transitory computer-readable medium of Clause 15, wherein the instructions when executed by the processor, further cause the processor to:
determine, based at least in part the one or more first sound signals and the one or more second sound signals, that the autonomous vehicle is traveling on rumble strips; and
instruct the autonomous vehicle to slow down.

Clause 19. The non-transitory computer-readable medium of Clause 15, wherein:
a first instance of the microphone array is disposed on a left side of the autonomous vehicle; and
a second instance of the microphone array is disposed on a right side of the autonomous vehicle.

Clause 20. The non-transitory computer-readable medium of Clause 15, wherein:
the one or more first sound signals comprise a first sound signal; and
amplifying the one or more first sound signals, comprises amplifying each of the one or more first sound signals with a particular amplification order, wherein the first sound signal is amplified with a first amplification order.

1. A system comprising:
a microphone array comprising a plurality of sound sensors, wherein the microphone array is mounted on an autonomous vehicle, and configured to:
detect one or more first sound signals from one or more first sound sources;
detect one or more second sound signals from one or more second sound sources;
a processor associated with the autonomous vehicle, and configured to:
receive the one or more first sound signals;
receive the one or more second sound signals;
amplify the one or more first sound signals;
disregard the one or more second sound signals, wherein the one or more second sound signals comprise interference noise signals;
determine that the one or more first sound signals indicate that a vehicle is within a threshold distance from the autonomous vehicle and traveling in a direction toward the autonomous vehicle; and
instruct the autonomous vehicle to perform a minimal risk maneuver operation in response to determining that the one or more first sound signals indicate that the vehicle is within the threshold distance from the autonomous vehicle and traveling in the direction toward the autonomous vehicle.

2. The system of claim 1, wherein the minimal risk maneuver operation comprises pulling the autonomous vehicle over to a side of a road.

3. The system of claim 1, wherein the minimal risk maneuver operation comprises stopping the autonomous vehicle.

4. The system of claim 1, wherein the processor is further configured to facilitate autonomous driving of the autonomous vehicle using at least the one or more first sound signals, wherein the autonomous driving of the autonomous vehicle is improved in response to disregarding the one or more second sound signals.

5. The system of claim 1, wherein:
the one or more first sound signals comprise a first sound signal; and
amplifying the one or more first sound signals, each with a particular amplification order, comprises amplifying the first sound signal with a first amplification order.

6. The system of claim 1, wherein:
the microphone array is arranged in a one-dimension (1D) plane;
the 1D plane is a plane in space parallel to a road travelled by the autonomous vehicle; and
the microphone array is further arranged in a uniform linear array such that each two adjacent sound sensors are disposed with a particular distance from each other.

7. The system of claim 1, wherein:
the microphone array is arranged in a one-dimension (1D) plane;
the 1D plane is a plane in space parallel to a road travelled by the autonomous vehicle;
the microphone array is further arranged in a non-linear array such that a first subset of sound sensors are disposed with a first distance from each other and a second subset of sound sensors are disposed with a second distance from each other; and
the first distance is different from the second distance.

8. A method comprising:
receiving, from a microphone array, one or more first sound signals from one or more first sound sources;
receiving, from a microphone array, one or more second sound signals from one or more second sound sources;
amplify the one or more first sound signals;
disregarding the one or more second sound signals, wherein the one or more second sound signals comprise interference noise signals;
determining that the one or more first sound signals indicate that a vehicle is within a threshold distance from an autonomous vehicle and traveling in a direction toward the autonomous vehicle; and
instructing the autonomous vehicle to perform a minimal risk maneuver operation in response to determining that the one or more first sound signals indicate that the vehicle is within the threshold distance from the autonomous vehicle and traveling in the direction toward the autonomous vehicle.

9. The method of claim 8, wherein:
the microphone array is arranged in a two-dimension (2D) plane and in two rows;
a first subset of sound sensors of the microphone array are arranged in a first row of the two rows;
the first subset of sound sensors of the microphone array are further arranged in a linear array such that each two adjacent sound sensors are disposed with a particular distance from each other;
a second subset of sound sensors of the microphone array are arranged in a second row of the two rows; and
the second subset of sound sensors of the microphone array are arranged in a linear array such that each two adjacent sound sensors are disposed with a particular distance from each other.

10. The method of claim 8, wherein:
the microphone array is arranged in a two-dimension (2D) plane and in two rows;
a first subset of sound sensors of the microphone array are arranged in a first row of the two rows;
the first subset of sound sensors of the microphone array are further arranged in a non-linear array;
a second subset of sound sensors of the microphone array are arranged in a second row of the two rows; and
the second subset of sound sensors of the microphone array are further arranged in a non-linear array.

11. The method of claim 8, wherein the one or more first sound sources comprise the vehicle or a passenger vehicle.

12. The method of claim 8, wherein the one or more first sound signals comprise an emergency vehicle siren or a passenger vehicle horn.

13. The method of claim 8, wherein the one or more second sound sources comprise rain, wind, or vehicle tires.

14. The method of claim 8, wherein the one or more second sound signals comprise a rainfall sound, a wind sound, a vehicle tire sound, or a rumble strip sound.

15. A non-transitory computer-readable medium storing instructions that when executed by a processor, cause the processor to:
receive, from a microphone array, one or more first sound signals from one or more first sound sources;
receive, from a microphone array, one or more second sound signals from one or more second sound sources;
amplify the one or more first sound signals;
disregard the one or more second sound signals, wherein the one or more second sound signals comprise interference noise signals;
determine that the one or more first sound signals indicate that a vehicle is within a threshold distance from an autonomous vehicle and traveling in a direction toward the autonomous vehicle; and
instruct the autonomous vehicle to perform a minimal risk maneuver operation in response to determining that the one or more first sound signals indicate that the vehicle is within the threshold distance from the autonomous vehicle and traveling in the direction toward the autonomous vehicle.

16. The non-transitory computer-readable medium of claim 15, wherein amplifying the one or more first sound signals comprises amplifying the one or more first sound signals only coming from front of and/or back of the autonomous vehicle.

17. The non-transitory computer-readable medium of claim 15, wherein:
each of the one or more first sound signals originate from a particular sound source from among the one or more first sound sources;
each of the one or more first sound signals has a particular frequency band;
each of the one or more second sound signals is originated from a particular sound source from among the one or more second sound sources;
the one or more second sound signals are different from the one or more first sound signals;
the one or more second sound sources are different from the one or more first sound sources; and
the instructions further cause the processor to separate the one or more second sound signals from the one or more first sound signals.

18. The non-transitory computer-readable medium of claim 15, wherein the instructions when executed by the processor, further cause the processor to:
determine, based at least in part the one or more first sound signals and the one or more second sound signals, that the autonomous vehicle is traveling on rumble strips; and
instruct the autonomous vehicle to slow down.

19. The non-transitory computer-readable medium of claim 15, wherein:
a first instance of the microphone array is disposed on a left side of the autonomous vehicle; and
a second instance of the microphone array is disposed on a right side of the autonomous vehicle.

20. The non-transitory computer-readable medium of claim 15, wherein:
the one or more first sound signals comprise a first sound signal; and
amplifying the one or more first sound signals, comprises amplifying each of the one or more first sound signals with a particular amplification order, wherein the first sound signal is amplified with a first amplification order.
